(19) United States
(12) Patent Application Publication
(10) Pub. No.: US 2025/0028063 A1
(43) Pub. Date: Jan. 23, 2025

(54) POSITIONING METHOD AND APPARATUS UTILIZING NAVIGATION SATELLITE SYSTEM

(71) Applicant: Beijing Tusen Zhitu Technology Co., LTD., Beijing (CN)

(72) Inventors: Henan Zhou, Beijing (CN); Naiyan Wang, Beijing (CN)

(73) Assignee: Beijing Tusen Zhitu Technology Co., LTD., Beijing (CN)

(21) Appl. No.: 18/776,989

(22) Filed: Jul. 18, 2024

(30) Foreign Application Priority Data
Jul. 21, 2023 (CN) 202310906784.3

(51) Int. Cl. G01S 19/48; G01S 19/39

(52) U.S. Cl. CPC G01S 19/485; G01S 19/396

(57) ABSTRACT

The present disclosure provides a positioning method utilizing a navigation satellite system, including receiving, by a receiver on a target object, a signal from the navigation satellite system; obtaining, based on the signal, pseudo-range information and phase information; calculating distance consistency information of a plurality of particles with respect to the pseudo-range information; calculating phase consistency information of the plurality of particles with respect to the phase information based on the wavelength of the signal; and calculating weights of the plurality of particles based on the distance consistency information and the phase consistency information to estimate positioning information of the target object through a particle filter. In addition, the present disclosure also provides a positioning apparatus and a computer-readable storage medium that can perform the method described above.

### CROSS-REFERENCE TO RELATED APPLICATIONS

The present disclosure claims priority to Chinese Patent Application No. 202310906784.3, titled “POSITIONING METHOD AND APPARATUS UTILIZING NAVIGATION SATELLITE SYSTEM”, filed on Jul. 21, 2023, the content of which is incorporated herein by reference in its entirety.

### TECHNICAL FIELD

The present disclosure relates to a positioning technique, and in particular to a particle filter based positioning method and apparatus utilizing a navigation satellite system, and a computer-readable storage medium.

### BACKGROUND

At present, Global Navigation Satellite System (GNSS) is a common outdoor positioning technology. Due to the existence of signal occlusion, multi-path effects and other problems, there would be great positioning errors of GNSS in some environments, which may cause positioning failure. In order to improve the positioning accuracy and robustness, a plurality of positioning modules are usually provided on the same target object, and then positioning information of the target object is obtained by fusing the positioning information of the plurality of positioning modules. This may leverage the strengths and mitigate the shortcomings of various positioning modules. Common positioning sensors include GNSS, Inertial Measurement Unit (IMU), cameras, and the like. Regarding the coupling of the GNSS to other sensors, the relatively front-end technology are for example the coupling of GNSS to IMU and the coupling of GNSS, IMU and camera.

However, in terms of accuracy, tight coupling of GNSS and other sensor such as IMU and cameras can achieve accuracies on the order of meters at most, and such accuracies cannot meet many scenarios (e.g., autonomous driving), and solutions have yet to be proposed to improve accuracy.

On the other hand, in view of the complexity of the algorithm, it is necessary to solve the ambiguity of whole cycles to improve the positioning accuracy in the current carrier phase observation of GNSS. However, the ambiguity of whole cycles resolution is a complex mathematical problem, which requires a lot of computational time and resources. Especially when the scene such as occlusion is involved, the ambiguity of whole cycles of carrier phase observation will lead to a cycle slip. In this case, the ambiguity of whole cycles needs to be re-solved and fixed, and the computational time and resources of the ambiguity of whole cycles resolution need to be consumed again.

### SUMMARY

In view of the above, the present disclosure proposes a positioning method and apparatus utilizing a navigation satellite system, and a computer-readable storage medium, which can circumvent the resolving process of the ambiguity of whole cycles by using the natural characteristics of a particle filter and a particle evaluation method different from the conventional carrier phase. Accordingly, computational time and resources can be saved.

A first aspect of the present disclosure provides a positioning method utilizing a navigation satellite system, including receiving, by a receiver on a target object, a signal from the navigation satellite system; obtaining, based on the signal, pseudo-range information and phase information; calculating distance consistency information of a plurality of particles with respect to the pseudo-range information; calculating phase consistency information of the plurality of particles with respect to the phase information based on the wavelength of the signal; and calculating weights of the plurality of particles based on the distance consistency information and the phase consistency information to estimate positioning information of the target object through a particle filter.

A second aspect of the present disclosure provides a positioning apparatus utilizing a navigation satellite system, including one or more processors, and a memory storing a program. The program includes instructions which, when executed by the processor, cause the positioning apparatus to perform the positioning method described above.

A third aspect of the present disclosure provides a computer-readable storage medium storing a program including instructions which, when executed by one or more processors of a computing apparatus, cause the computing device to perform the positioning method.

### BRIEF DESCRIPTION OF THE DRAWINGS

The accompanying drawings, which are incorporated in and constitute a part of this description, illustrate embodiments and, together with the description, serve to explain exemplary implementations of the embodiments. It is obvious that the figures in the following description are only some embodiments of the present invention, and it would have been obvious for a person skilled in the art to obtain other figures according to these figures without involving any inventive effort. Throughout the drawings, the same reference numerals indicate similar but not necessarily identical elements.

FIG. 1 is a block diagram illustrating a positioning apparatus according to an embodiment of the present disclosure.

FIG. 2 is a flow chart illustrating a positioning method according to an embodiment of the present disclosure.

FIG. 3 is a schematic diagram illustrating phase information calculation according to an embodiment of the present disclosure.

FIG. 4 is a flow chart illustrating fusing other perception information to compute weights for a plurality of particles according to an embodiment of the present disclosure.

FIG. 5 is a flow chart illustrating computing pose consistency information of a particle with respect to perception information of a camera according to an embodiment of the present disclosure.

FIG. 6 is a flow chart illustrating computing pose consistency information of a particle with respect to perception information of a lidar (Light Detection and Ranging) device according to an embodiment of the present disclosure.

FIG. 7 is a schematic diagram illustrating a vehicle in which various techniques disclosed herein may be implemented.

FIG. 8 is a schematic diagram illustrating a computing device according to an embodiment of the present disclosure.

### DETAILED DESCRIPTION

In order to make the objects, technical solutions and advantages of the present invention more apparent, the present invention will be described in further detail with reference to the accompanying drawings. Based on the embodiments of the present invention, all other embodiments obtained by a person skill in the art without inventive effort fall within the scope of the present invention.

In the present disclosure, the term “a plurality of” means two or more, unless otherwise specified. In the present disclosure, the term “and/or” describes an associated relationship of associated objects and encompasses any and all possible combinations of the listed objects. The character “/” generally indicates that the associated object is an OR relationship.

In the present disclosure, unless otherwise noted, the use of the terms “first”, “second”, and the like are used to distinguish between similar objects and are not intended to limit their positional, temporal, or importance relationships. It is to be understood that the terms so used are interchangeable under appropriate circumstances such that the embodiments of the present invention described herein are capable of operation in other ways than those illustrated or otherwise described herein.

Moreover, the terms “include” and “have”, as well as any variations thereof, are intended to cover a non-exclusive inclusion, such that a process, method, system, product, or device that includes a list of steps or elements is not necessarily limited to those steps or elements expressly listed, but may include other steps or elements not expressly listed or inherent to such process, method, system, product, or apparatus.

Embodiments of the present disclosure proposes a positioning method utilizing a navigation satellite system, comprising: receiving, by a receiver on a target object, a signal from the navigation satellite system; obtaining, based on the signal, pseudo-range information and phase information; calculating distance consistency information of a plurality of particles with respect to the pseudo-range information; calculating phase consistency information of the plurality of particles with respect to the phase information based on a wavelength of the signal; and calculating weights of the plurality of particles based on the distance consistency information and the phase consistency information to estimate positioning information of the target object through a particle filter.

In an embodiment, the positioning method further comprises calculating a plurality of satellite-to-ground distances between the plurality of particles and the navigation satellite system based on coordinate information of the navigation satellite system.

In an embodiment, calculating distance consistency information of the plurality of particles with respect to the pseudo-range information comprises calculating distance consistency information of the plurality of particles with respect to the pseudo-range information based on the plurality of satellite-to-ground distances.

In an embodiment, calculating the phase consistency information of the plurality of particles with respect to the phase information based on the wavelength of the signal comprises: calculating respectively a plurality of phase differences generated when the signal passes through the plurality of satellite-to-ground distances based on the wavelength; and calculating the phase consistency information of the plurality of particles with respect to the phase information based on the plurality of phase differences.

In an embodiment, calculating weights of the plurality of particles based on the distance consistency information and the phase consistency information to estimate positioning information of the target object through a particle filter comprises: fusing perception information from a camera and a lidar installed on the target object to calculate the weights of the plurality of particles.

In an embodiment, fusing the perception information from the camera and the lidar to calculate the weights of the plurality of position particles comprises: calculating first pose consistency information of the plurality of particles with respect to the perception information of the camera; calculating second pose consistency information of the plurality of particles with respect to the perception information of the lidar; and calculating the weights of the plurality of particles based on the distance consistency information, the phase consistency information, the first pose consistency information, and the second pose consistency information.

In an embodiment, calculating the first pose consistency information of the plurality of particles with respect to the perception information of the camera comprises: detecting a reference target in an image from the camera to obtain a detection result; converting the reference target and the detection result to the same coordinate system based on the plurality of particles, and calculating the first pose consistency information based on the reference target and the detection result in the same coordinate system.

In an embodiment, converting the reference target and the detection result to the same coordinate system based on the plurality of particles comprises: projecting the reference target onto the image based on the plurality of particles to obtain a projection result. The calculating the first pose consistency information based on the reference target and the detection result in the same coordinate system comprises: calculating the first pose consistency information based on the detection result and the projection result.

In an embodiment, calculating the second pose consistency information of the plurality of particles with respect to the perception information of the lidar comprises: determining a plurality of features in a prior map matched with a plurality of points in a point cloud of the lidar; converting the plurality of points and the matched plurality of features onto the same coordinate system based on the plurality of particles; and calculating the second pose consistency information based on the plurality of points and the plurality of features in the same coordinate system.

In an embodiment, converting the plurality of points and the matched plurality of features onto the same coordinate system based on the plurality of particles comprises: converting the plurality of points in the point cloud into a world coordinate system based on the plurality of particles to obtain a plurality of converted points. Calculating the second pose consistency information based on the plurality of points and the plurality of features in the same coordinate system, comprising: calculating the second pose consistency information based on the plurality of converted points and the plurality of features.

In an embodiment, calculating the second pose consistency information based on the plurality of points and the plurality of features in the same coordinate system comprises: calculating the second pose consistency information based on a feature type of the features matched by the plurality of points, wherein the feature type comprises one of a line feature, a face feature, and a distribution feature.

In an embodiment, determining the plurality of features that the plurality of points in the point cloud of the lidar match in the prior map comprises: for each of the plurality of converted points, searching for the closest feature in the prior map within the pre-set neighborhood radius; and taking the closest features as the features that the converted points match.

In an embodiment, obtaining the pseudo-range information and the phase information based on the signal comprises: obtaining the pseudo-range information and the phase information using a differential positioning method based on the signal.

In an embodiment, the differential positioning method comprises a double difference observation positioning method.

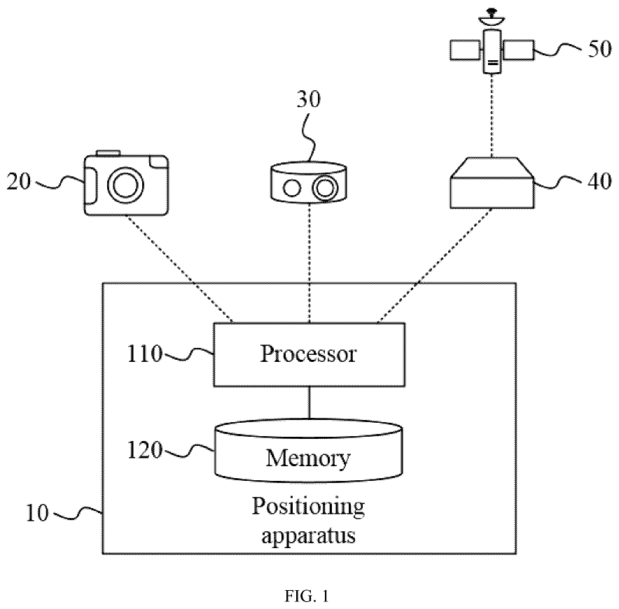

FIG. 1 is a block diagram illustrating a positioning apparatus according to an embodiment of the present disclosure.

Referring to FIG. 1, the positioning apparatus 10 includes one or more processors 110 and a memory 120. The memory 120 is configured to store a program including a plurality of instructions that, when executed by the processor 110, cause the positioning apparatus 10 to perform the positioning method as will be described in the present disclosure. The components of the processor 110 and the memory 120 will be described later.

According to the positioning method as will be described in the present disclosure, a target object is positioned with the aid of a navigation satellite system 50 to obtain positioning information for the target object. Thus, when the positioning apparatus 10 is in operation, the processor 110 is coupled to a receiver 40 provided on the target object for receiving signals from the navigation satellite system 50.

In some embodiments, the positioning information includes position information.

In some embodiments, the positioning information, also called pose information, includes position information and orientation information.

In some embodiments, the target object is, for example, a vehicle. However, the present disclosure does not limit the type of target object so that a person skilled in the art can select a positioned object as desired.

In some embodiments, the navigation satellite system 50 is, for example, the Global Navigation Satellite System (GNSS). However, the present disclosure does not so limit the type of the navigation satellite system 50. In some embodiments, the navigation satellite system 50 may also be a regional navigation satellite system or a combination of a GNSS and a regional navigation satellite system.

In some embodiments, in addition to utilizing data of the navigation satellite system 50, the processor 110 may fuse data of the navigation satellite system 50 with data of other sensors in performing the positioning method in order to improve the accuracy and robustness of positioning. For example, the processor 110 may fuse data of the navigation satellite system 50 with data of a camera 20 and a lidar 30 when performing the positioning method. Accordingly, the processor 110 is also coupled to the camera 20 and the lidar 30 provided on the target object. It must be noted that the present disclosure does not limit the type and number of other sensors, and in some embodiments, the processor 110 may also, for example, fuse data of the navigation satellite system 50 with data of an Inertial Measurement Unit (IMU) when performing the positioning method.

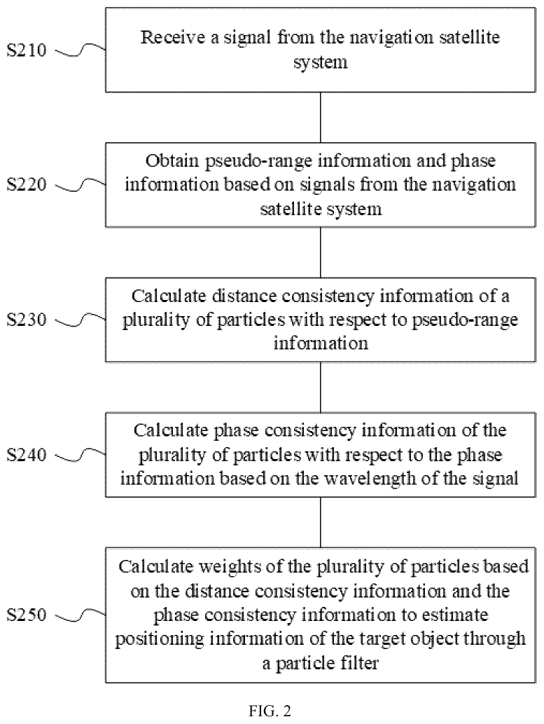

FIG. 2 is a flow chart illustrating a positioning method according to an embodiment of the present disclosure.

The description associated with the embodiment of FIG. 2 will be described in conjunction with the positioning apparatus 10 of FIG. 1 and will not be repeated as already described in connection with the embodiment of FIG. 1.

Referring to FIG. 2, in step S210, a signal from the navigation satellite system 50 are received. For example, the receiver 40 on the target object may receive the signal from the navigation satellite system 50 and forward it to the positioning apparatus 10. In step S220, Pseudo Range information and phase information are obtained based on the signal from the navigation satellite system 50.

In some embodiments, the satellite navigation system 50 is, for example, a GNSS, and the signal from the GNSS includes information such as Timestamp and/or initial phase. The satellite navigation system 50 may use radio wave as carrier to transmit the signal.

In particular, the pseudo-range information indicates, for example, the satellite-to-ground distance between the GNSS (satellite navigation system 50) and the receiver 40, which is the observation of the receiver 40. Since the timestamp in the GNSS signal includes information of the transmission time of the GNSS signal (i.e., time when the GNSS transmits or emit the signal), the receiver 40 or the processor 110 can calculate the pseudo-range information by comparing the reception time, when the receiver 40 receives the signal, with the transmission time indicated by the timestamp. For example, the pseudo-range may be calculated by multiplying the difference between the reception time and the transmission time indicated by the timestamp by the speed of light. In some embodiments, the signal from the GNSS also includes information such as navigation data and multipath effects that can be used to correct the above calculations to obtain more accurate pseudo-range information.

On the other hand, the phase information is associated with a phase difference between the initial phase of the radio wave when the GNSS transmits the signal and a reception phase. Specifically, the phase information is a part (the decimal part) of the phase difference which is less than one cycle. The phase information can be measured by the phase detector of the receiver 40. The reception phase is the phase of the radio wave when the phase detector of the receiver 40 receive the signal. In some embodiments, the information of the initial phase is contained, for example, in a GNSS signal, although the present disclosure is not limited thereto.

In some embodiments, the pseudo-range information and phase information are derived by a differential positioning method, for example, based on the GNSS signal. For example, based on the GNSS signal, pseudo-range information p and phase information rP derived from double difference observations may be represented by the following Formulas (1) and (2), respectively.

$$p = r \qquad Formula ( 1 )$$

$$φ = {λ}^{- 1} r - N \qquad Formula ( 2 )$$

where r is, for example, a satellite-to-ground distance calculated based on the timestamp; λ is, for example, the wavelength of the GNSS signal (i.e., the wavelength of the carrier); N is the number of whole cycles of the phase difference between the initial phase and the reception phase. Usually, the phase detector of the receiver 40, when receiving the GNSS signal, can only measures the phase information φ that is less than one cycle. N is therefore called the ambiguity of whole cycles, which requires the so-called ambiguity resolution.

It must be noted that, in order to simplify the description, the phase in the present disclosure is expressed using the wavelength of the signal as a basic unit, not an arc. Moreover, in some embodiments, pseudo-range information and phase information may also be derived from single difference observations, and the present disclosure is not limited thereto.

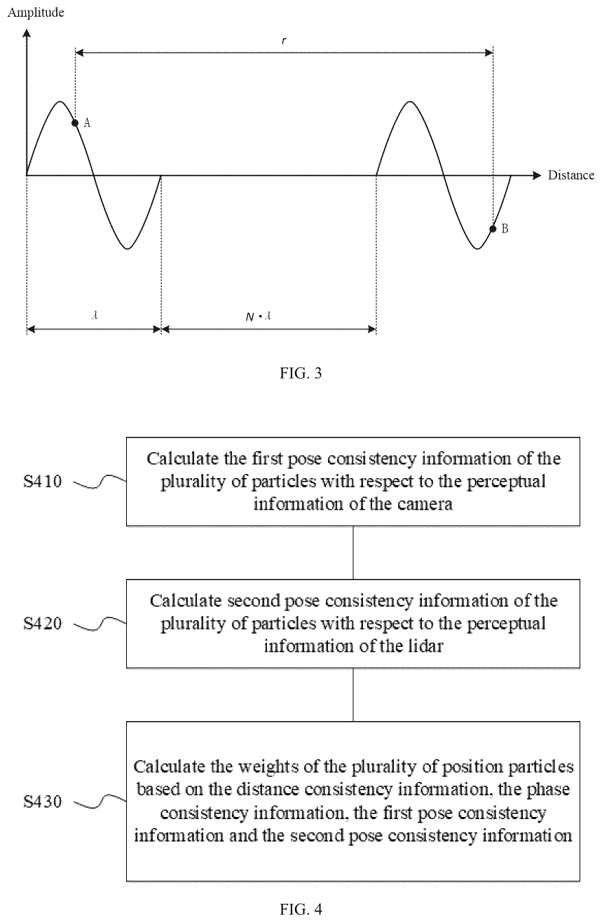

FIG. 3 is a schematic diagram illustrating phase information calculation according to an embodiment of the present disclosure.

Referring to FIG. 3, the satellite-to-ground distance r is, for example, the distance, from the transmitting point A of the GNSS signal to the receiving point B where the receiver 40 is positioned, calculated based on the timestamp. If the initial phase of the GNSS signal from GNSS (or the radio wave) is φ_{A} and the reception phase is φ_{B}, then the phase information φ (associated with the difference between φ_{B} and φ_{A}) can be derived from the satellite-to-ground distance r, the wavelength λ, and the ambiguity of whole cycles N (as in Formula (2)).

In order to avoid solving the ambiguity of whole cycles N, the positioning method proposed by the present disclosure is performed by a particle filter (i.e., PF algorithm), and thus requires computing consistency information between a plurality of particles with respect to an observed result.

The PF algorithm is a state estimation method based on the Monte Carlo method. It uses particles to simulate the state (e.g., pose) of an actual object (also called true state). Each particle is an estimation of the state of the actual object. Thus, each particle may have property such as position and orientation as the estimation of the state of the corresponding actual object. In other word, each particle can represent particular position and orientation. The algorithm uses observation data (such as data from sensors) to calculate the likelihood of each particle relative to the state of the actual object and then calculate the weight of each particle. The weighted average of particles with high weights can accurately represent the state of the real system.

To put it simply, a round of particle filter algorithm includes the steps of Resample, state Transition. Likelihood estimation, and Weight updating. Consistency information is used to estimate the likelihood of a particle compared to the true state to further calculate the weight of the particle. In some cases, the more consistent a particle is with an observed result, the higher the likelihood, and the higher the weight. Very low-weight particles will be rejected at the next round of resampling, and the final positioning result is obtained by a weighted average of the remaining particles.

The algorithmic details of the particle filter are not critical to the present disclosure and are therefore not discussed in detail.

It should be noted that, in the present application, particles are used to estimate the position, orientation or both of the target object.

In some embodiments, in order to calculate consistency information between the plurality of particles with respect to the observed results, processor 110 may first calculate a plurality of satellite-to-ground distances between the plurality of particles and the navigation satellite system 50. For example, satellite coordinate information of the GNSS is included in the GNSS signal, for example, and the plurality of satellite-to-ground distances ri between the plurality of particles and the GNSS can be calculated by the following Formula (3):

$${r}_{i} = {‖ {x}_{sat} - {x}_{i} , {y}_{sat} - {y}_{i} , {z}_{sat} - {z}_{i} ‖}_{2} \qquad Formula ( 3 )$$

wherein [xᵢ, yᵢ, zᵢ] is, for example, the positions of the particles (i.e., positions represented by the particles), i being used to differentiate different particles; [xₛₐₜ, yₛₐₜ, zₛₐₜ] are, for example, the position of the satellite. Without being specifically stated, the present disclosure describes a position by a world coordinate system, such as an Earth-Centered Earth-Fixed (ECEF) coordinate system or an ENU coordinate system.

Returning to FIG. 2, in step S230, the processor 110 calculates distance consistency information for the plurality of particles with respect to the pseudo-range information.

In particular, the distance consistency information of the plurality of particles with respect to the pseudo-range information is used to evaluate the consistency of the observed pseudo-range information and the satellite-to-ground distance between each particle and the navigation satellite system 50.

In some embodiments, the distance consistency information may be expressed in the form of a loss function, for example, for ease of description of likelihood. For example, the distance consistency information of the plurality of particles with respect to the pseudo-range information p may be described by a function fp of the following Formula (4):

$${f}_{p} = p - {r}_{i} \qquad Formula ( 4 )$$

In step S240, the processor 110 calculates phase consistency information for the plurality of particles with respect to the phase information based on the wavelength of the signal from the navigation satellite system 50.

In particular, the phase consistency information of the plurality of particles with respect to the phase information is used to evaluate the consistency of the phase information and the phase difference between the initial phase and the reception phase. Here it is assumed that the particles each correspond to the same signal from the navigation satellite system 50.

In some embodiments, the phase consistency information may be expressed in the form of a loss function, for example, for ease of description of likelihood. For example, the phase consistency information of the plurality of particles with respect to the phase information φ may be described by a function ƒ_{φ} of the following Formula (5):

$${f}_{φ} = φ - ( \frac{{r}_{i}}{λ} - ⌊ \frac{{r}_{i}}{λ} ⌋ ) \qquad Formula ( 5 )$$

It can be seen from Formula (5) that since the particle filter includes natural properties such as computing consistency information and likelihood, the complex resolution process of ambiguity of whole cycles is avoided skillfully.

$$⌊ \frac{{r}_{i}}{λ} ⌋$$

means rounding down

$$\frac{{r}_{i}}{λ} .$$

In step S250, the processor 110 calculates weights of the plurality of particles based on the distance consistency information and the phase consistency information to estimate positioning information of the target object through the particle filter.

In particular, the distance consistency information can be used to estimate the likelihood of observation of particles based on pseudo-range information, and the phase consistency information can be used to estimate the likelihood of observation of the particles based on the phase information.

In some embodiments, the likelihood of observation based on pseudo-range information may be described, for example, by the function p_{PSR} in Formula (6) below:

$${p}_{PSR} ( {z}_{t} \vert {x}_{t} ) = {e}^{- \frac{1}{2} \frac{1}{{σ}_{PSR}^{2}} {f}_{p} ( {P}_{{x}_{t}} )} \qquad Formula ( 6 )$$

wherein t, for example, represents time; zₜ, for example, represents an observation or observed result; xₜ, for example, represents a single particle; ƒₚ is, for example, the distance consistency information (loss function of the pseudo-range) of Formula (4); Pₓ_{ₜ} is, for example, the position represented by the particle; σ_{PSR} is, for example, the standard deviation of the loss of the pseudo-range observation (e.g., a hyperparameter obtained statistically or otherwise).

In some embodiments, the likelihood of observation based on phase information may be described, for example, by the function p_{CPD} in Formula (7) below:

$${p}_{CPD} ( {z}_{t} \vert {x}_{t} ) = {e}^{- \frac{1}{2} \frac{1}{{σ}_{CPD}^{2}} {f}_{φ} ( {P}_{{x}_{t}} )} \qquad Formula ( 7 )$$

wherein t, for example, represents time; zₜ, for example, represents an observation or observed result; xₜ, for example, represents a single particle; ƒ_{φ} is, for example, the phase consistency information (loss function of phase) of Formula (5); Pₓ_{ₜ} is, for example, the position represented by the particle; σ_{CPD} is, for example, the standard deviation of the loss of the phase observation (e.g., a hyperparameter obtained statistically or otherwise).

After obtaining likelihoods of the particles based on various observation, the likelihood can be used to estimate the probability that the particle is close to the true value based on the observed results, which is equivalent to obtaining the weight of the particle. Subsequently, resampling is performed until convergence, so that the positioning result of the target object, i.e., the positioning information, can be obtained by a weighted average of the remaining plurality of particles.

It is worth mentioning that the positioning information may have errors when only a single satellite is used, because the resolution of the ambiguity of whole cycles N is avoided. The positioning information obtained by the particle filter is quite accurate when a plurality of satellites are observed at the same time.

In some embodiments, in order to improve the accuracy and robustness of the positioning method, other perception information (e.g., observed results) from other sensors are further fused in step S250. In particular, in the particle filter technique, in order to fuse other perception information from other sensors, for each sensor, likelihoods of observation of a plurality of particles with respect to the perception information of the sensor may be calculated, and then weights of the plurality of particles may be calculated by fusing all the observation likelihoods. Moreover, similar to the method described in the previous paragraph, the observation likelihood may be calculated by calculating consistency information (e.g., using a loss function) of the plurality of particles with respect to the perception information of the sensors.

FIG. 4 is a flow chart illustrating fusing other perception information to compute weights for a plurality of particles according to an embodiment of the present disclosure. In the FIG. 4 embodiment, the fused other sensors include the camera 20 and the lidar 30 installed on the target object. However, the present disclosure is not so limited, and the other sensors for the fusion may also include any sensor (e.g., an inertial measurement unit) associated with pose observations.

In some embodiments, in addition to the distance consistency information and the phase consistency information, pose consistency information is also used to calculate weights of the particles. Specifically, referring to FIG. 4, step S250 further includes steps S410, S420, and S430, for example.

In step S410, the first pose consistency information of the plurality of particles with respect to the perception information of the camera 20 is calculated.

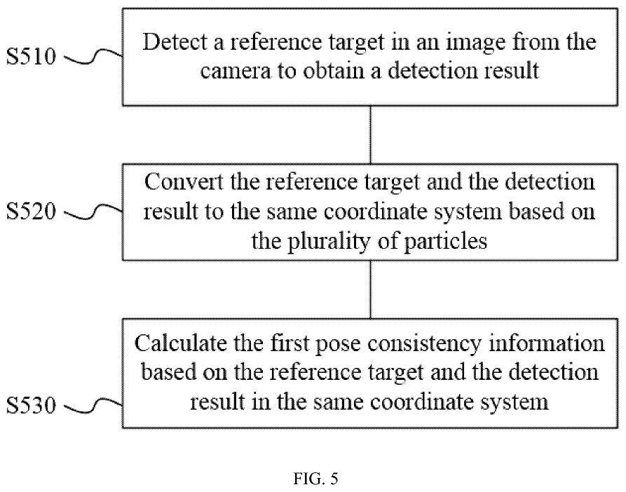

FIG. 5 is a flow chart illustrating computing pose consistency information of with respect to perception information of the camera according to an embodiment of the present disclosure.

Referring to FIG. 5, in some embodiments, step S410 further includes steps S510-S530, for example.

In step S510, a reference target is detected in an image captured by the camera 20 to obtain a detection result.

In some embodiments, the reference target is, for example, a lane line. Information about the lane line, for example the real pose of the lane line (such as real coordinates of a plurality of points of the lane line), can be obtained from a prior map (e.g., a map with lanes, such as a High-precision map). The processor 110 may detect a lane line from the image as a detection result, for example. The detected lane line includes, for example, a plurality of points in the image (also referred to as detection points) corresponding to the points of the lane line obtained from the prior map. The detection result includes detected pose of the lane line, such as detected coordinates of the detection points.

However, the present disclosure is not limited thereto, and any other object whose coordinates can be known in advance can be used as a reference target.

In step S520, real pose of the reference target and the detection result are converted to the same coordinate system based on the plurality of particles. In particular, since the particles carry position and orientation information, which are the estimation of the position and orientation of the target object, the information of the particles can be used to convert real pose of the reference target and the detection result to the same coordinate system.

In some embodiments, by the conversion, the processor 110 may project real coordinates of the plurality of points of the lane line onto the image to obtain a plurality of projected points on the image.

In step S530, the first pose consistency information is calculated based on the real pose of reference target and the detection result in the same coordinate system. In particular, by comparing the real pose of the reference target and the detection result in the same coordinate system, it is possible to obtain the first pose consistency information of the particles relative to the perception information of the camera 20, i.e., indicating that the likelihood of the particle with respect to observation of the camera 20 can be obtained.

In some embodiments, the first pose consistency information may be represented by a loss function based on a distance transform image.

For example, the observation likelihood of the plurality of particles with respect to the perception information of the camera 20 may be described by the function p_{cam} in Formula (8) below:

$${p}_{cam} ( {z}_{t} \vert {x}_{t} ) = {e}^{- \frac{1}{2} \frac{1}{N {σ}_{cam}^{2}} {\sum }_{i = 0}^{N} {f}_{dt} ( {KT}_{cam}^{imu} {T}_{{x}_{t}}^{- 1} {P}_{i} )} \qquad Formula ( 8 )$$

wherein t, for example, represents time; zₜ, for example, represents an observation or observed result; xₜ, for example, represents a single particle; ƒ_{dt} is, for example, the first pose consistency information (e.g., a loss function based on a distance transform image, i.e., a value taken from the distance transform image using two-dimensional pixel coordinates). If the pose of the particle is more correct, the value taken from the distance transform image is closer to 0); K is, for example, an intrinsic matrix of the camera, that is, a matrix for conversion from a camera coordinate system to an image plane coordinate system-Pi is, for example, a point (also known as a sample point) on a lane line in the map with lanes (e.g., in an world coordinate system), more specifically, the real coordinates of the point; N is, for example, the total number of the sample points; σ_{cam} is, for example, the standard deviation of observation of the camera 20 (e.g., a hyperparameter obtained statistically or otherwise); Tₓ_{ᵢ} is, for example, the conversion matrix corresponding to the position and orientation of the particle, i.e., a matrix for conversion from the IMU coordinate system to the world coordinate system according to the position and orientation of the particle; T_{cam}^{inu} is, for example, an extrinsic matrix of the camera 20, that is, a matrix for conversion from the IMU coordinate system to the camera coordinate system. Therefore, KT_{cam}^{imu}Tₓ_{ₜ}⁻¹Pₜ is a process of projecting the sample point on the lane line in the world coordinate system to the image plane to obtain two-dimensional pixel coordinates. It should be noted that, the origin of the IMU coordinate system is on the IMU mounted on the target object. The world coordinate system can be an ENU coordinate system.

In some embodiments, the first consistency information may also be calculated by converting the detection result in the image to a coordinate system in which the reference target is positioned, or by converting both the detection result in the image and the reference target in the map to another coordinate system, and the present disclosure is not limited thereto.

In step S420, second pose consistency information of the plurality of particles with respect to the perception information of the lidar 30 is calculated.

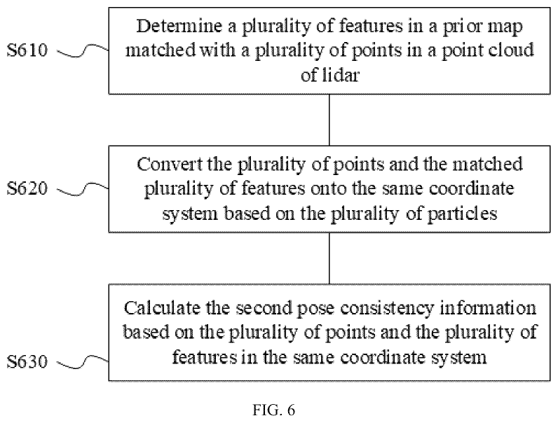

FIG. 6 is a flow chart illustrating computing pose consistency information of particles with respect to perception information of a lidar according to an embodiment of the present disclosure.

Referring to FIG. 6, in some embodiments, step S420 further includes steps S610-S630, for example.

In step S610, a plurality of features in a prior map which match a plurality of points in a point cloud captured by the lidar 30 are determined; and in step S620, the plurality of points and the matched plurality of features are converted to the same coordinate system based on the plurality of particles.

In particular, the prior map may contain a number of features, for example features of different feature types such as line features, face features or distribution features. The prior map may be generated in advance for example according to point clouds captures by lidars or is a High-precision map. For each point in the point cloud, an attempt is made to find a feature in the prior map that matches the point. For example, a point in the point cloud may correspond to a lane line edge, and steps 610 and S620 may attempt to find a line feature in the prior map representing the lane line edge that this point matches, and convert the point and the matched feature into the same coordinate system.

Since the particles carry position and orientation information, in some embodiments, the processor 110 may first transform all points in the point cloud into the world coordinate system based on the plurality of particles to obtain a plurality of converted points. Then, for each converted point in the world coordinate system, the closest feature in the prior map within a pre-set neighborhood radius is searched as the matched feature. For example, a specified point in the point cloud is converted into a specified converted point in the world coordinate system, and the processor 110 searches for a feature within a pre-set neighborhood radius in the prior map that is closest to the specified converted point and takes this feature as the feature that the specified converted point matches. As such, each converted point and matched feature may be determined and positioned in the same coordinate system (e.g., the world coordinate system).

In step S630, the second pose consistency information is calculated based on the plurality of points and the plurality of features in the same coordinate system.

In particular, by comparing the converted points with the matched features, it can be determined whether the points in the point cloud are consistent with the features in the prior map, that is to say, obtaining second pose consistency information of the particle with respect to the perception information of the lidar 30 which indicates that the observation likelihood of the particle with respect to the lidar 30 can be obtained.

For example, the observation likelihood that the plurality of particles correspond to the perception information of the lidar 30 may be described by the function p_{lidar} in Formula (9) below:

$${p}_{lidar} ( {z}_{t} \vert {x}_{t} ) = {e}^{- \frac{1}{2} \frac{1}{N {σ}_{lidar}^{2}} {\sum }_{i = 0}^{N} {f}_{LF} ( {T}_{{x}_{t}} {T}_{cam}^{imu} {P}_{i} )} \qquad Formula ( 9 )$$

wherein t, for example, represents time; zₜ, for example, represents an observation or observed result; xₜ, for example, represents a single particle, Pᵢ is a point (or the coordinates of the point) in a point cloud captured by the lidar 30 in the lidar 30 coordinate system; Tₓ_{ᵢ} is, for example, the conversion matrix corresponding to the position and orientation of the particle, i.e., a matrix for conversion from the IMU coordinate system to the world coordinate system according to the position and orientation of the particle; Tᵢₘᵤ^{lidar} is the external matrix of the lidar 30, that is, a matrix for conversion from the lidar 30 coordinate system to an IMU coordinate system. Therefore, Tₓ_{ᵢ}Tᵢₘᵤ^{lidar}Pᵢ is a matrix operation for converting a point in the lidar 30 coordinate system to a world coordinate system. Moreover, N is, for example, the total number of the points in the point cloud, ƒ_{LF} is, for example, second pose consistency information (e.g., loss function based on the features in the prior map); σ_{cam} is, for example, the standard deviation of observation of the lidar 30 (e.g., a hyperparameter obtained statistically or otherwise).

It must be noted that the loss function ƒ_{LF} is calculated differently for particles matching different feature types. In other words, the calculation of the second pose consistency information is based on the feature type that the points match.

For example, a loss function ƒ_{LF,Line} of a point that matches a line feature, can be described by the following Formula (10):

$${f}_{LF , Line} = {{ω}_{Line} ( {[ \vec{a} ]}_{\times } ( {P}_{w} - {P}_{a} ) )}^{2} \qquad Formula ( 10 )$$

Where ω_{Line} is, for example, a weight of a line feature (e.g., a hyperparameter); P_{w} is, for example, a point in the world coordinate system by for example converting the point in the point cloud into the world coordinate system; \vec{α} is, for example, a unit vector of a line feature; Pa is, for example, a point in a line feature of the prior map, [ ]ₓ for example represents an antisymmetric matrix. To put it simply, calculating the second pose consistency information using Formula (10) is equivalent to calculating the distance between the point and the matched line feature.

For example, a loss function ƒ_{LF,Plane} of a point that matches a face feature can be described by the following Formula (11):

$${f}_{LF , Plane} = {{ω}_{Plane} ( {\vec{a}}^{T} ( {P}_{w} - {P}_{a} ) )}^{2} \qquad Formula ( 11 )$$

where ω_{Plane} is, for example, a weight of a face feature (for example, a hyperparameter); P_{w} is, for example, a point in the world coordinate system by for example converting the point in the point cloud into the world coordinate system; \vec{α} is for example a normal vector of the face feature; P_{α} is, for example, a point in the face feature of the prior map. To put it simply, calculating the second pose consistency information using Formula (11) is equivalent to calculating the distance between the point and the matched face feature.

For example, a loss function ƒ_{LF,Dist} of a point that matches a distribution feature can be described by the following Formula (12):

$${f}_{LF , Dist} = {{ω}_{Dist} ( {P}_{w} - {P}_{a} )}^{T} {Σ}^{- 1} ( {P}_{w} - {P}_{a} ) \qquad Formula ( 12 )$$

where ω_{Dist} is, for example, a weight of a distribution feature (e.g., a hyperparameter); P_{w} is, for example, a point in the world coordinate system by for example converting the point in the point cloud into the world coordinate system; Σ is for example a covariance matrix of the distribution feature; P_{α} is, for example, an average point of the distribution feature of the prior map.

Thus, for each point in the point cloud, calculating second consistency information based on the feature type of the matched feature (e.g., calculating a loss function) can obtain the observation likelihood of a plurality of particles corresponding to the perception information of the lidar 30 (e.g., via Formula (9)).

Returning to FIG. 4, in step S430, the weights of the plurality of particles are calculated based on the distance consistency information ƒₚ, the phase consistency information ƒ_{φ}, the first pose consistency information fa and the second pose consistency information ƒ_{LF}.

In particular, the observation likelihood of the plurality of particles with respect to the pseudo-range information p may be obtained based on the distance consistency information ƒₚ (e.g., Formula (6)), the observation likelihood of the plurality of particles with respect to the phase information V can be obtained based on the phase consistency information ƒ_{φ} (e.g., Formula (7)); the observation likelihood of the plurality of particles with respect to the camera 20 may be obtained based on the first pose consistency information ƒ_{dt} (e.g., Formula (8)); the observation likelihood of the plurality of particles with respect to the perception information of the lidar 30 may be obtained based on the second pose consistency information ƒ_{LF} (e.g., Formulas (9)-(12)). Next, the weights of the plurality of particles can be obtained based on the above-mentioned likelihoods by the particle filter. Thus, the positioning information of the target object can be estimated by the particle filter.

The way the particle weights, resampling and subsequent weighted averaging are obtained based on known likelihoods should be known to a person skilled in the art from the technical document involving particle filters and will not be described in detail here.

Advantageously, by fusing other perception information from other sensors (e.g., camera 20 and lidar 30), the accuracy and robustness of the positioning method is ensured. For example, positioning information can be obtained accurately by fusing other sensors, even if only one satellite remains available, even if satellite observations are unavailable due to occlusion, and the like.

The particles mentioned in the above embodiments refer to pose particles used by conventional particle filters, i.e., may include at least one of the position information and the orientation information. In some embodiments, to further improve the accuracy and robustness of the positioning method, reliability particles can for example be introduced into the particle filter in addition to the pose particles.

For example, after introducing reliability particles, Formulas (6) and (7) can be replaced by Formulas (13) and (14) below, respectively:

$${p}_{PSR} ( {z}_{t} \vert {x}_{t} , {r}_{t} ) = {e}^{- \frac{1}{2} \frac{1}{{σ}_{PSR}^{2}} {f}_{p} ( {P}_{{x}_{t}} ) {r}_{t}} \qquad Formula ( 13 )$$

$${p}_{CPD} ( {z}_{t} \vert {x}_{t} , {r}_{t} ) = {e}^{- \frac{1}{2} \frac{1}{{σ}_{CPD}^{2}} {f}_{φ} ( {P}_{{x}_{t}} ) {r}_{t}} \qquad Formula ( 14 )$$

For example, after introducing reliability particles, Formulas (8) and (9) can be replaced by Formulas (15) and (16) below, respectively:

$${P}_{cam} ( {z}_{t} \vert {x}_{t} , {r}_{t} ) = {e}^{- \frac{1}{2} \frac{1}{N {σ}_{cam}^{2}} {\sum }_{i = 0}^{N} {f}_{dt} ( {KT}_{cam}^{imu} {T}_{{x}_{t}}^{- 1} {P}_{i} ) {r}_{t}} \qquad Formula ( 15 )$$

$${P}_{lidar} ( {z}_{t} \vert {x}_{t} , {r}_{t} ) = {e}^{- \frac{1}{2} \frac{1}{N {σ}_{lidar}^{2}} {\sum }_{i = 0}^{N} {f}_{LF} ( {T}_{{x}_{t}} {T}_{cam}^{imu} {P}_{i} ) {r}_{t}} \qquad Formula ( 16 )$$

For details on the way of introducing reliability particles into a particle filter and the calculation of particle weights, reference may be made, for example, to the patent No. CN113008245B, and which is incorporated herein by reference in its entirety and will not be repeated by the present disclosure.

Advantageously, by introducing reliability particles, the corresponding reliability can be estimated for each satellite in the navigation satellite system 50, and the observation weights of the low reliability satellites are reduced when calculating the weights. As such, even when the number of observable satellites is reduced (e.g., less than 4), positioning can be accurately accomplished.

A positioning method using the satellite navigation system 50 is proposed through various embodiments. The proposed positioning method can not only save the computational time and resources needed to solve the ambiguity of whole cycles, but also ensure the accuracy and robustness of positioning.

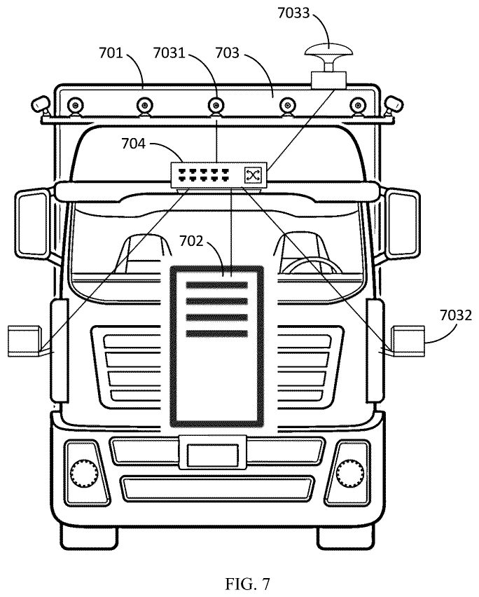

FIG. 7 is a schematic diagram illustrating a vehicle in which various techniques disclosed herein may be implemented.

In some embodiments, the positioning method described in the present disclosure may be implemented, for example, on a computing device on a vehicle 701, and the target object may be, for example, a vehicle 701 itself.

In detail, the vehicle 701 may be a car, a truck, a motorcycle, a bus, a boat, an airplane, a helicopter, a lawn mower, an excavator, a snowmobile, an aircraft, a recreational vehicle, an amusement park vehicle, a farm apparatus, a construction device, a tram, a golf cart, a train, a trolleybus, or other vehicles. The vehicle 701 may be fully or partially operated in an automatic driving mode. The vehicle 701 may control itself in the automatic driving mode, e.g., the vehicle 701 may determine a current state of the vehicle and a current state of an environment in which the vehicle is positioned, determine a predictive behavior of at least one other vehicle in the environment, determine a level of trust corresponding to a likelihood that the at least one other vehicle will perform the predictive behavior, and control the vehicle 701 itself based on the determined information. While in the automatic driving mode, the vehicle 701 may operate without human interaction.

Take an autonomous vehicle as an example for the vehicle 701, and an intelligent system is an autonomous system. In a conventional case, as shown in FIG. 7, the autonomous vehicle 701 equipped with a server 702 (i.e., a vehicle server) on the autonomous vehicle), and the autonomous vehicle is also provided with various sensors 703, such as an image acquisition device (such as a camera 7031), a lidar 7032 and a navigation satellite system (for example, a GNSS) signal receiver (such as an integrated navigation device 7033), and the like; a switch 704 is generally provided between the sensor 703 and the server 702, so that the sensor 703 and the server 702 are connected via the switch 704 to form a data transmission path of a network bus. The server 702 may be an intelligent system server. The server 702 can implement the positioning apparatus 10 of FIG. 1, the camera 7031 can implement the camera 20 of FIG. 1, the lidar 7032 can implement the lidar 30 of FIG. 1, and the integrated navigation device 7033 can implement the receiver 40 of FIG. 1.

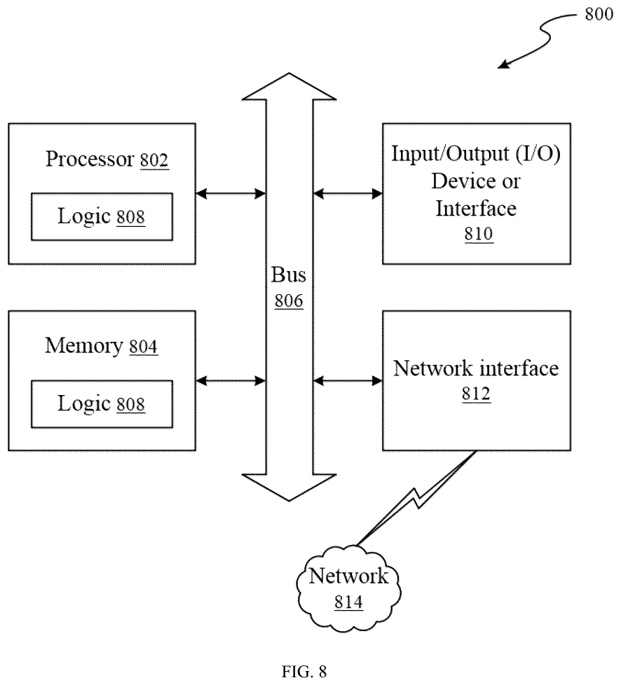

FIG. 8 is a schematic diagram illustrating a computing device according to an embodiment of the present disclosure.

In some embodiments, the positioning apparatus 10 may be implemented in the form of a computing device 800.

In some embodiments, the server 702 may be implemented in the form of a computing device 800.

FIG. 8 illustrates a diagram of a machine in the example form of a computing device 800 within which instruction sets, when executed, and/or processing logic, when initiated, may cause the machine to perform any one or more of the methods described and/or claimed herein. In alternative embodiments, the machine operates as a standalone device, or may be connected (e.g., networked) to other machines. In a networked deployment, a machine may operate in the identity of a server or client machine in a server-client network environment, or as a peer in a peer-to-peer (or distributed) network environment. A machine may be a personal computer (PC), a laptop computer, a tablet computing system, a personal digital assistant (PDA), a cellular telephone, a smart phone, a network appliance, a set-top box (STB), a network router, switch or bridge, or any machine capable of executing a set of instructions that specify actions to be taken by that machine, either sequentially or otherwise, or initiate processing logic. Further, although only a single machine is illustrated, the term “machine” may also be understood to include any collection of machines that individually or jointly execute a set of instructions (or sets of instructions) to perform any one or more of the methods described and/or claimed herein.

The example computing device 800 may include a data processor 802 (e.g., a system (SoC), a general-purpose processing core, a graphics core, and optionally other processing logic) and a memory 804 (e.g., memory) that may communicate with each other via a bus 806 or other data transfer systems. The computing device 800 can also include various input/output (I/O) devices and/or interfaces 810, such as a touch screen display, an audio jack, a voice interface, and an optional network interface 812. In an example embodiment, the network interface 812 may include one or more radio transceivers configured to interface with any one or more standard wireless and/or cellular protocols or access technologies (e.g., second-generation (2G), 2.5-generation, third-generation (3G), fourth-generation (4G) and next-generation radio access for cellular systems, Global Mobile Communication System (GSM), General Packet Radio Service (GPRS), Enhanced Data GSM Environment (EDGE), Wideband Code Division Multiple Access (WCDMA), LTE, CDMA2000, WLAN, Wireless Router (WR) grid, and the like). The network interface 812 may also be configured for use with various other wired and/or wireless communication protocols including TCP/IP, UDP, SIP, SMS, RTP, WAP, CDMA, TDMA, UMTS, UWB, WiFi, WiMax, Bluetooth©, IEEE802.11x, and the like. In essence, the network interface 812 may include or support virtually any wired and/or wireless communication and data processing mechanism by which information/data may travel between the computing device 800 and another computing or communication system via network 814.

The memory 804 can represent a machine-readable medium (or computer-readable storage medium) on which is stored thereon one or more sets of instructions, software, firmware, or other processing logic (e.g., logic 808) that implement any one or more of the methods or functions described and/or claimed herein. The logic 808, or a portion thereof, may also reside, completely or at least partially, within the processor 802 during execution by the computing device 800. As such, the memory 804 and the processor 802 may also constitute a machine-readable medium (or computer-readable storage medium). The logic 808 or a portion thereof may also be configured as processing logic or logic, at least a portion of which is partially implemented in hardware. The logic 808 or a portion thereof may also be transmitted or received over network 814 via the network interface 812. Although the machine-readable medium (or computer-readable storage medium) of the example embodiments may be a single medium, the term “machine-readable medium” (or computer-readable storage medium) should be taken to include a single non-transitory medium or a plurality of non-transitory media (e.g., a centralized or distributed database and/or associated caches and computing systems) that store the one or more sets of instructions. The term “machine-readable medium” (or computer-readable storage medium) may also be understood to include any non-transitory medium that can store, encode or carry a set of instructions for execution by the machine and that cause the machine to perform any one or more of the methods of the various embodiments, or that can store, encode or carry data structures utilized by or associated with such a set of instructions. The term “machine-readable medium” (or computer-readable storage medium) can thus be interpreted to include, but is not limited to, solid-state memories, optical media, and magnetic media.

The disclosed and other embodiments, modules, and functional operations described in this document may be implemented in digital electronic circuitry, or in computer software, firmware, or hardware (including the structures disclosed in this document and their structural equivalents), or in combinations of one or more of them. The disclosed and other embodiments may be implemented as one or more computer program products, that is, one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “the data processing apparatus” encompasses all apparatus, devices, and machines for processing data, including, for example, a programmable processor, a computer, or a plurality of processors or computers. In addition to hardware, the apparatus can include code that creates an execution environment for the computer program in discussion, such as code that constitutes processor firmware, a protocol stack, a database management system, an operating system, or a combination of one or more of them. The propagated signal is an artificially generated signal, e.g., an electrical, optical or electromagnetic signal generated by a machine, that is generated to encode information to be transmitted to a suitable receiver apparatus.

A computer program (also referred to as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), or in a single file dedicated to the program in discussion, or in a plurality of collaboration files (e.g., files that store one or more modules, subroutines, or portions of code). A computer program can be deployed to be executed on one computer or on a plurality of computers that are positioned at one site or distributed across a plurality of sites and interconnected by a communication network.

The processes and logic flows described in this document may be executed by one or more programmable processors executing one or more computer programs to perform functions by operating on input data and generating output. The processes and logic flows can also be performed by, and apparatus can also be implemented as, special-purpose logic circuitry, e.g., a field programmable gate array (FPGA) or an application-specific integrated circuit (ASIC).

The processors suitable for the execution of a computer program include, by way of example, both general and special-purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices (e.g., magnetic, magneto-optical disks, or optical disks) for storing data. However, a computer need not have such a device. Computer-readable media suitable for storing computer program instructions and data include all forms of non-volatile memory, media and memory devices, including by way of example semiconductor memory devices, such as EPROM, EEPROM and flash memory devices; a magnetic disk, such as an internal hard disk or a removable disk; magneto-optical disks; and CD-ROM discs and DVD-ROM discs. The processor and memory may be supplemented by, or incorporated in, special-purpose logic circuitry.

Some embodiments described herein are described in the general context of a method or process, which in one embodiment may be implemented by a computer program product embodied in a computer-readable medium, which may include computer-executable instructions (such as program code), which may be executed, for example, by computers in networked environments. The computer-readable media can include removable and non-removable storage devices including, but not limited to, Read Only Memory (ROM), Random Access Memory (RAM), Compact Disks (CD), Digital Versatile Disks (DVD), and the like. Thus, a computer-readable medium can include a non-transitory storage medium. Generally, program modules may include routines, programs, objects, components, data structures, and the like that perform particular tasks or implement particular abstract data types. Computer or processor executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments may be implemented as a device or module using hardware circuitry, software, or a combination thereof. For example, a hardware circuit implementation may include discrete analog and/or digital components, which may be integrated as part of a printed circuit board, for example. Alternatively or additionally, the disclosed components or modules may be implemented as Application Specific Integrated Circuit (ASIC) and/or Field Programmable Gate Array (FPGA) devices. Additionally or alternatively, some implementations may include a Digital Signal Processor (DSP) that is a dedicated microprocessor with an architecture optimized for the operational needs of digital signal processing associated with the disclosed functionality of the present application. Similarly, the various components or sub-assemblies within each module may be implemented in software, hardware, or firmware. Any connection method and medium known in the art may be used to provide connections between modules and/or components within modules, including, but not limited to, communication over the Internet, a wired network, or a wireless network using an appropriate protocol.

Although many details are included herein, these should not be construed as limiting the scope of the claimed invention, but rather as describing features specific to particular embodiments. Certain features that are described herein in the context of separate embodiments may also be combined in a single embodiment. Conversely, various features that are described in the context of a single embodiment can also be implemented in a plurality of embodiments separately or in any suitable subcombination. Furthermore, while features may be described above as acting in certain combinations and even initially claimed, one or more features from a claimed combination may in some cases be excised from the combination, and the claimed combination may be directed to a subcombination or variation of a subcombination. Similarly, while operations are depicted in the drawings in a particular order, this should not be understood as requiring that such operations be performed in the particular order shown or in a sequential order, or that all illustrated operations be performed, to achieve desired results.

Only a few embodiments and examples are described, and other implementations, enhancements, and variations can be made based on what is described and shown in the present disclosure.

1-20. (canceled)

21. A positioning method, comprising:
receiving a signal from a navigation satellite system through a receiver on a target object;
obtaining, based on the signal, pseudo-range information and phase information;
determining distance consistency information of a plurality of particles with respect to the pseudo-range information, wherein each particle is an estimation of a state of the target object;
determining phase consistency information of the plurality of particles with respect to the phase information based on a wavelength of carrier of the signal; and
determining weights of the plurality of particles based on the distance consistency information and the phase consistency information to estimate positioning information of the target object.

22. The positioning method according to claim 21, further comprising:
determining a plurality of satellite-to-ground distances between positions represented by the plurality of particles and the navigation satellite system.

23. The positioning method according to claim 22, wherein determining distance consistency information of the plurality of particles with respect to the pseudo-range information comprises:
determining the distance consistency information of the plurality of particles with respect to the pseudo-range information based on the plurality of satellite-to-ground distances.

24. The positioning method according to claim 22, wherein determining the phase consistency information of the plurality of particles with respect to the phase information based on the wavelength of the signal comprises:
determining a plurality of phase differences based on the plurality of satellite-to-ground distances and the wavelength; and
determining the phase consistency information of the plurality of particles with respect to the phase information based on the plurality of phase differences.

25. The positioning method according to claim 21, wherein determining weights of the plurality of particles based on the distance consistency information and the phase consistency information to estimate positioning information of the target object comprises:
determining first pose consistency information of the plurality of particles with respect to perception information of a camera on the target object;
determining second pose consistency information of the plurality of particles with respect to perception information of a lidar on the target object; and
determining the weights of the plurality of particles based on the distance consistency information, the phase consistency information, the first pose consistency information, and the second pose consistency information.

26. The positioning method according to claim 25, wherein determining the first pose consistency information of the plurality of particles with respect to the perception information of the camera comprises:
detecting a reference target in an image captured by the camera to obtain a detection result;
obtaining pose information of the reference target from a map; and
determining the first pose consistency information based on the pose information and the detection result.

27. The positioning method according to claim 26, wherein determining the first pose consistency information of the plurality of particles with respect to the perception information of the camera further comprises:
converting the pose information and the detection result to a same coordinate system based on the plurality of particles.

28. The positioning method according to claim 27, wherein the pose information of the reference target comprises coordinates of a plurality of points of the reference target,
wherein converting the pose information and the detection result to the same coordinate system based on the plurality of particles, comprising:
projecting the plurality of points of the reference target onto the image based on the coordinates of the plurality of points and the plurality of particles to obtain a projection result,
wherein the determining the first pose consistency information based on the pose information and the detection result further comprises:
determining the first pose consistency information based on the detection result and the projection result.

29. The positioning method according to claim 25, wherein determining the second pose consistency information of the plurality of particles with respect to the perception information of the lidar comprises:
determining a plurality of features in a map matched with a plurality of points in a point cloud captured by the lidar; and
determining the second pose consistency information based on the plurality of points and the plurality of features.

30. The positioning method according to claim 29, wherein determining the second pose consistency information of the plurality of particles with respect to the perception information of the lidar further comprises:
converting the plurality of points and the plurality of features onto a same coordinate system based on the plurality of particles.

31. The positioning method according to claim 30, wherein determining a plurality of features in a map matched with a plurality of points in a point cloud captured by the lidar comprises:
for each of the plurality of points, searching for one of the plurality of features in the map within a pre-set neighborhood radius which is closest to the point, as a feature matched with the point.

32. The positioning method according to claim 21, wherein the pseudo-range information indicates a distance value calculated based on time when the receiver receives the signal and a timestamp included in the signal.

33. The positioning method according to claim 21, wherein the phase information indicates a phase value detected by the receiver and associated with a phase difference between an initial phase of the carrier when the navigation satellite system transmits the signal and a reception phase of the carrier when the receiver receives the signal.

34. A positioning apparatus, comprising:
one or more processors, and
a memory storing a program comprising instructions which, when executed by the processor, cause the positioning apparatus to perform operations comprising:
receiving a signal from a navigation satellite system through a receiver on a target object;
obtaining, based on the signal, pseudo-range information and phase information;
determining distance consistency information of a plurality of particles with respect to the pseudo-range information, wherein each particle is an estimation of a state of the target object;
determining phase consistency information of the plurality of particles with respect to the phase information based on a wavelength of carrier of the signal; and
determining weights of the plurality of particles based on the distance consistency information and the phase consistency information to estimate positioning information of the target object.

35. The apparatus according to claim 34, wherein the operations further comprise:
determining a plurality of satellite-to-ground distances between positions represented by the plurality of particles and the navigation satellite system.

36. The apparatus according to claim 35, wherein determining distance consistency information of the plurality of particles with respect to the pseudo-range information comprises:
determining the distance consistency information of the plurality of particles with respect to the pseudo-range information based on the plurality of satellite-to-ground distances.

37. The apparatus according to claim 35, wherein determining the phase consistency information of the plurality of particles with respect to the phase information based on the wavelength of the signal comprises:
determining a plurality of phase differences based on the plurality of satellite-to-ground distances and the wavelength; and
determining the phase consistency information of the plurality of particles with respect to the phase information based on the plurality of phase differences.

38. A non-transitory computer-readable storage medium storing a program, the program comprising instructions which, when executed by one or more processors of a computing apparatus, cause the computing device to perform operations comprising:
receiving a signal from a navigation satellite system through a receiver on a target object;
obtaining, based on the signal, pseudo-range information and phase information;
determining distance consistency information of a plurality of particles with respect to the pseudo-range information, wherein each particle is an estimation of a state of the target object;
determining phase consistency information of the plurality of particles with respect to the phase information based on a wavelength of carrier of the signal; and
determining weights of the plurality of particles based on the distance consistency information and the phase consistency information to estimate positioning information of the target object.

39. The computer-readable storage medium according to claim 38, wherein determining weights of the plurality of particles based on the distance consistency information and the phase consistency information to estimate positioning information of the target object comprises:
determining first pose consistency information of the plurality of particles with respect to the perception information of a camera on the target object;
determining second pose consistency information of the plurality of particles with respect to the perception information of a lidar on the target object; and
determining the weights of the plurality of particles based on the distance consistency information, the phase consistency information, the first pose consistency information, and the second pose consistency information.

40. The computer-readable storage medium according to claim 39, wherein determining the first pose consistency information of the plurality of particles with respect to the perception information of the camera comprises:
detecting a reference target in an image captured by the camera to obtain a detection result;
obtaining pose information of the reference target from a map; and
determining the first pose consistency information based on the pose information and the detection result.
wherein determining the second pose consistency information of the plurality of particles with respect to the perception information of the lidar comprises:
determining a plurality of features in another map matched with a plurality of points in a point cloud captured by the lidar; and
determining the second pose consistency information based on the plurality of points and the plurality of features.
